(19) United States
(12) Patent Application Publication
(10) Pub. No.: US 2008/0155222 A1
(43) Pub. Date: Jun. 26, 2008

(54) COMPUTER SYSTEM

(76) Inventor: Megumu HASEGAWA, Hadano (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/958,803

(22) Filed: Dec. 18, 2007

(30) Foreign Application Priority Data
Dec. 22, 2006 (JP) 2006-345181

(51) Int. Cl. G06F 12/00

(52) U.S. Cl. 711/173; 711/E12.002

(57) ABSTRACT

In an open-system server including a bus of the industrial normal standards, a control register is mapped in memory space and IO space and a device having only one control register for controlling the device can be accessed from a plurality of operating systems operated under control of the LPAR control program simultaneously. In a computer system, the LPAR control program virtually maps the memory space and IO space of one physical device to each of the operating systems. Further, the LPAR control program divides the single computer system into a plurality of logical partitions (LPAR) and assigns an LPAR identifier for specifying the LPAR to each LPAR.

### INCORPORATION BY REFERENCE

The present application claims priority from Japanese application JP2006-345181 filed on Dec. 22, 2006, the content of which is hereby incorporated by reference into this application.

### BACKGROUND OF THE INVENTION

The present invention relates to a computer system including a plurality of operating systems (OS) which can be operated simultaneously in the single computer system and a control register which can perform processing from the plurality of operating systems with one physical device mapped in memory space and IO space simultaneously.

Until now, a mainframe supports the LPAR (logical partition) function which operates a plurality of operating systems under control of an LPAR control program in one system.

Recent years, not only the mainframe but also an open-system server is supporting the LPAR function. When the open-system server supports the LPAR function, the number of devices to be mounted is limited and it is required to share one device by a plurality of operating systems. However, in the case of the mainframe which shares input/output resources, a lot of input/output resources supported by the mainframe are based on peculiar specification of mainframe vendor and it is difficult to realize the LPAR function by the open-system server which supports the device based on the industrial normal standards.

In the open-system server, the device is inserted into a slot of the open-system server and a PCI (peripheral component interchange) bus worked out by PCI-SIG is widely used as measures of the industrial normal standards for connecting with a host processor. The PCI bus includes a PCI configuration register provided for each device normally and only one control register for controlling the device, so that it is difficult to share the device by a plurality of operating systems due to the above reason.

JP-A-6-35725 (corresponding to U.S. Pat. No. 5,414,851A, Brice, Jr. et. al) discloses an example of sharing input/output resources by a mainframe, for example. In this example, space (HAS) which can be accessed in common by all of operating systems operated in different resource sections (LPAR) in one computer system and can be also accessed by a device is provided and individual control information of each operating system is prepared in the HSA, so that the input/output resources can be shared. Further, JP-A-64-37636 discloses the technique that section identifiers are defined and the section identifier is set in start information, so that a section (guest) to be interrupted is specified by the section identifier upon IO interrupt.

### SUMMARY OF THE INVENTION

As described above, JP-A-6-35725 and JP-A-64-37636 describe the examples of sharing the input/output resources by the mainframe. However, the open-system server including the bus of the industrial normal standards accesses the control register of the device mapped in the memory space and the IO space of the operating system to control the device. The access from the operating system to the mapped space forms direct access to the control register from the device, so that the device is controlled. Accordingly, if the physical device does not include the control registers equal in number to the sharing operating systems, accesses to the control register from the operating systems compete with one another and the result as expected cannot be obtained from the operating systems, so that it is impossible to realize the sharing.

Moreover, the open-system server does not include the space which can be accessed in common by all of operating systems operated in different resource sections (LPAR) in one computer system as the HSA, so that the realization of sharing is difficult.

Accordingly, it is an object of the present invention to provide technique that in an open-system server including a bus of the industrial normal standards and which is difficult to realize it in the prior arts such as JP-A-6-35725 and JP-A-64-37636, a control register is mapped in memory space and IO space and a device having only one control register for controlling the device can be accessed from a plurality of operating systems operated under control of the LPAR control program simultaneously.

The above and other objects and novel features of the present invention will be apparent from the following description of the specification taken in connection with the accompanying drawings.

An outline of representative aspects of the present invention disclosed in the specification is as follows. That is, the computer system according to the present invention has the following advantages.

(1) The LPAR control program includes means to divide the single computer system into a plurality of logical partitions (LPAR) and assign an LPAR identifier (ID) for specifying the LPAR to each LPAR.
(2) The LPAR control program includes means to map memory space and IO space of a physical (shared) device as virtual memory space and IO space independent for each of the operating systems in memory space and IO space of the plurality of operating systems operated under control of the LPAR control program.
(3) The LPAR control program traps access from each of the operating systems to the virtual memory space and IO space and adds the ID thereto to make access to physical memory space and IO space of the physical (shared) device, so that the LPAR control program makes writing in a hardware register in the physical (shared) device. The LPAR control program includes means to read an access result of writing by the physical (shared) device into the hardware register and the ID from the physical memory space and IO space and specify the LPAR on the basis of the ID to report the access result to the virtual memory space and IO space of the operating system operated in the specified LPAR.
(4) The physical (shared) device adds the ID to even an report to the operating system of an asynchronous event occurring in the physical (shared) device to make the report and the LPAR control program includes means to reflect the report to the virtual memory space and IO space of the operating system being operated in the LPAR indicated by the ID.

Effects obtained by representative aspects of the present invention disclosed in the specification are as follows. That is, according to the computer system of the present invention, the following effects can be attained.

(1) There can be provided the system in which the device for mapping the control register in the memory space or IO space is shared by a plurality of operating systems operated under control of the LPAR control program in an open-system server including a bus of the industrial normal standard.
(2) The device control program operated in the operating system is not conscious of sharing and is not required to be corrected.
(3) Since the device can be shared by the plurality of operating systems operated under control of the LPAR control program, the device is not required to have the control registers equal in number to the operating systems operated under control of the LPAR control program.
(4) When the LPAR control program accesses the physical memory space and IO space, the device merely reports the LPAR identifier (ID) for specifying the LPAR together with the access result, so that the device can be shared by the plurality of operating systems operated under control of the LPAR control program.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating a structure example (software) of a computer system according to an embodiment of the present invention;

FIG. 2 is a block diagram illustrating a configuration example (hardware) of the computer system according to the embodiment of the present invention;

FIG. 3 is a diagram illustrating spaces managed by user's operating systems in the computer system according to the embodiment of the present invention;

FIG. 4 is a diagram illustrating structure of a PCI card in the computer system according to the embodiment of the present invention;

FIG. 5 is a diagram illustrating control of the PCI card in a configuration in which only one operating system is operated in the single computer system according to the embodiment of the present invention;

FIG. 6 is a diagram illustrating control of the PCI card in a configuration in which a plurality of operating systems are operated in the single computer system according to the embodiment of the present invention;

FIG. 7 is a diagram illustrating a format of an operation indication field accessed by a control program in the operating system in the computer system according to the embodiment of the present invention;

FIG. 8 is a diagram illustrating a format of an execution result field accessed by the control program in the operating system in the computer system according to the embodiment of the present invention;

FIG. 9 is a diagram illustrating a format of an operation indication register in the PCI card in the computer system according to the embodiment of the present invention;

FIG. 10 is a diagram illustrating a format of an execution result register in the PCI card in the computer system according to the embodiment of the present invention;

FIG. 11 is a flow chart showing control of the PCI card in the computer system according to the embodiment of the present invention;

FIG. 12 is a flow chart continued to that of FIG. 11 and showing control of the PCI card in the computer system according to the embodiment of the present invention;

FIG. 13 is a diagram illustrating an operation instruction code management table in the computer system according to the embodiment of the present invention; and

FIG. 14 is a flow chart showing control of the PCI card having CMD-REG of queue structure in the computer system according to the embodiment of the present invention.

### DESCRIPTION OF THE EMBODIMENTS

Embodiments of the present invention are now described in detail with reference to the accompanying drawings. The like elements are designated by the like reference numerals in principle in all drawings used to describe the embodiments and repeated description thereof is omitted.

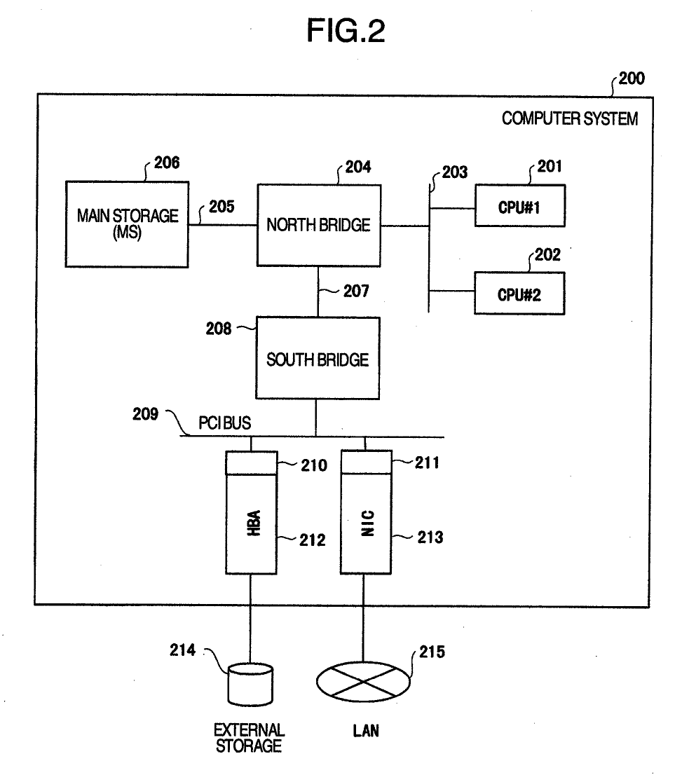

FIG. 2 illustrates a configuration example (hardware) of a computer system to which the present invention is applied. The computer system 200 includes central processing units 201 and 202, a north bridge 204, a main storage (MS) 206, a south bridge 208, PCI slots 210 and 211, a host bus adapter (HBA) 212, a network interface card (NIC) 213 and various buses and the computer system 200 is connected to an external storage 214 and a local area network (LAN) 215.

The computer system 200 includes a plurality of CPUs 201 and 202, which are connected through a front-side bus (FSB) 203 to the north bridge 204. The north bridge 204 is connected through a memory bus 205 to the main storage 206 and through a bus 207 to the south bridge 208. The south bridge 208 is connected through a PCI bus 209 to the PCI slots 210 and 211.

As an example of PCI cards mounted in the PCI slots 210 and 211, there are the host bus adapter (HBA) 212 connected to the external storage 214 and the network interface card (NIC) 213 connected to the LAN 215. In the embodiment, the PCI cards (hereinafter, the host bus adapter (HBA) 212 is referred to as a PCI card 212 and the network interface card (NIC) 213 is referred to as a PCI card 213) are described as devices to be shared by way of example.

The method of controlling the PCI cards 212 and 213 in the computer system 200 shown in FIG. 2 is described.

The computer system 200 shown in FIG. 2 includes memory space (MEM) 300 which is a memory area in which programs operated in an operating system and data processed by the programs are stored and IO space (IO) 301 which is a memory area for making communication with devices such as PCI cards 212, 213 and the like. Some of the PCI cards 212 and 213 include an area for making communication with programs operated in the operating system in the memory space (MEM) 300. The computer system 200 executes a request from a program operated in the operating system by performing reading and writing to the memory space (MEM) 300 and the IO space (IO) 301. PCI card memory space (MMIO) 302 and PCI card IO space (IOMIO) 303 are described later.

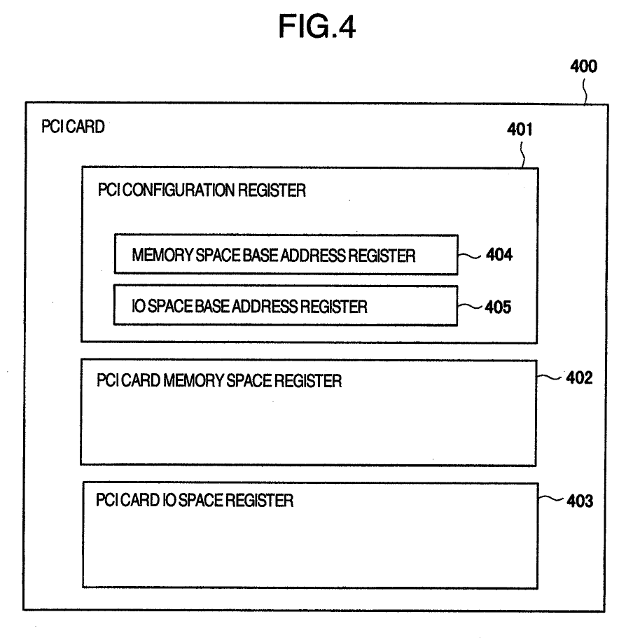

The PCI card 400 (corresponding to the PCI cards 212, 213 of FIG. 2) includes, as shown in FIG. 4, a PCI configuration register 401, a PCI card memory space register 402 and a PCI card IO space register 403 in accordance with the specification prescribed by PCI-SIG which is a group for studying the specification concerning the PCI. In order to make it possible to control the PCI card 400 from the operating system, start addresses for mapping of the spaces are set in a memory space base address register 404 and an IO space base address register 405 in the PCI configuration register 401. The PCI card memory space (MMIO) 302 is mapped in the area starting from the address set in the memory space base address register 404 of the memory space (MEM) 300 and the PCI card IO space (IOMIO) 303 is mapped in the area starting from the address set in the space base address register 405 of the IO space (IO) 301.

The PCI card 400 is controlled by performing reading and writing to the PCI card memory space (MMIO) 302 and the PCI card IO space (IOMIO) 303 mapped from the operating system.

Referring now to FIG. 5, the operation flow of controlling the PCI cards 212 and 213 using the PCI card memory space (MMIO) 302 from the operating system in the configuration in which the LPAR control program is not operated (only one operating system is operated in one computer system) is described.

In FIG. 5, only a user operating system 500 is operated and a PCI card driver 520 which is a program for controlling a PCI card 510 in the operating system is operated. Further, the operating system contains memory space (MEM) 501 and PCI card memory space (MMIO) 502 is mapped in the MEM 501. The MMIO 502 contains a field (CMD) 503 for accessing a control register (CMD-REG) 512 in the PCI card 510 for issuing operation instruction to the PCI card 510 from the PCI card driver 520 and a field (ST) 504 for accessing a control register (ST-REG) 513 in which the PCI card 510 sets an execution result code to the operation instruction.

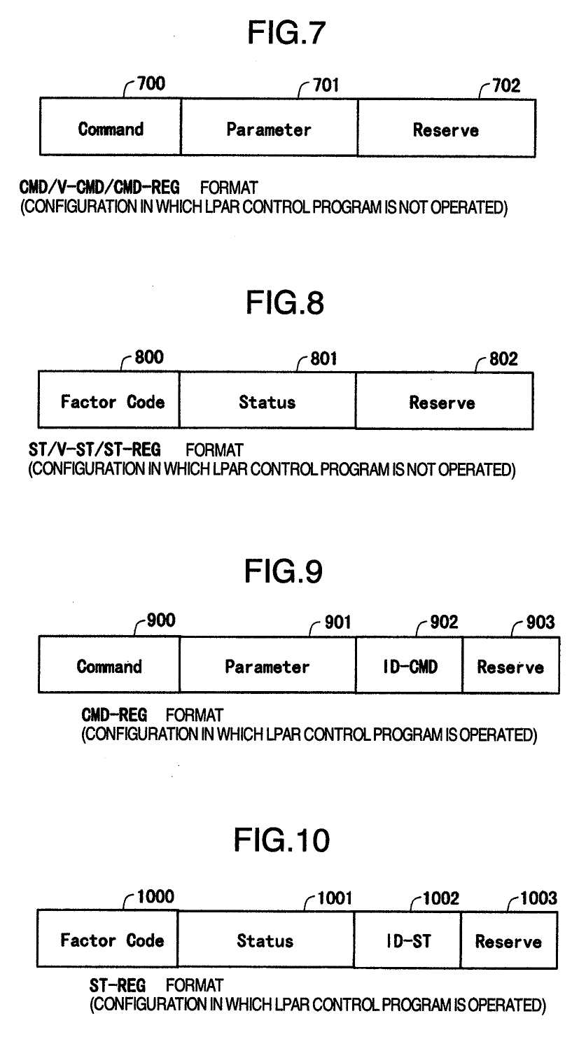

The formats of the CMD-REG 512 and the CMD 503 are common and an example thereof is shown in FIG. 7. Command (command field) 700 indicates operation which the PCI card 510 is made to perform, Parameter (parameter field) 701 indicates a parameter required to perform the operation indicated in Command 700, and Reserve (reserve field) 702 indicates an area which is not used currently. Further, the formats of the ST-REG 513 and the ST 504 are common and an example thereof is shown in FIG. 8. Factor Code (factor field) 800 indicates a factor to be reported by the PCI card, Status (status field) 801 indicates the status of the factor reported by Factor Code 800, and Reserve (reserve field) 802 indicates an area which is not used currently.

The PCI card driver 520 reads the CMD 503 and when it is cleared, the PCI card driver 520 writes the operation instruction code in the CMD 503. In the computer system 200, a writing operation instruction is issued to the memory from the CPU 201, 202 in response to the writing. The writing operation instruction is sent to the north bridge 204 through the front-side bus 203. The north bridge 204 judges that the writing operation instruction does not mean writing to the main memory (MS) 206 but means writing to the PCI cards 212, 213 and sends the writing operation instruction to the south bridge 208 through the bus 207. The south bridge 208 implements the writing transaction having as write data the operation instruction code written in the operating system to the PCI cards 212, 213. The operation instruction code is written in the CMD-REG 512 of the PCI card 510 in response to the implementation of the writing transaction. The operation instruction code is reported to the PCI card firmware 511 which controls the PCI card 510 in response to the writing.

The PCI card firmware 511 queues the received operation instruction code in a management table (TASK-LIST) 515 thereof and clears the CMD-REG 512. When the CMD 503 is read in response to the clearing, the cleared value is read, so that the PCI card driver 520 judges that a next operation instruction code can be written in the CMD 503. The PCI card firmware 511 processes a plurality of operation instruction codes in the TASK-LIST 515 in parallel. The processed operation instruction code is dequeued from the TASK-LIST 515 and the execution result code is written in the ST-REG 513. An interrupt is issued in the operating system in response to the writing. When the ST 504 is read from the PCI card driver 520 in response to the interrupt, the reading operation instruction from the CPU 201, 202 is sent through the front-side bus 203, the north bridge 204 and the bus 207 to the south bridge 208 in the same manner as the writing operation to the CMD 503. The south bridge 208 implements the transaction for reading the ST-REG 513 onto the PCI bus 209 and reads a value in the ST-REG 513. The read value is reported through the south bridge 208, the bus 207, the north bridge 204 and the front-side bus 203 to the CPU 201, 202 as the execution result code of the operation instruction.

In other words, in the configuration in which the LPAR control program is not operated (only one operating system is operated in one computer system), reading and writing of the MMIO 502 which is the PCI card memory space are performed from the operating system, so that reading and writing of a control register group 514 included in hardware of the PCI card 510 are performed to thereby control the PCI card 510 from the PCI card driver 520.

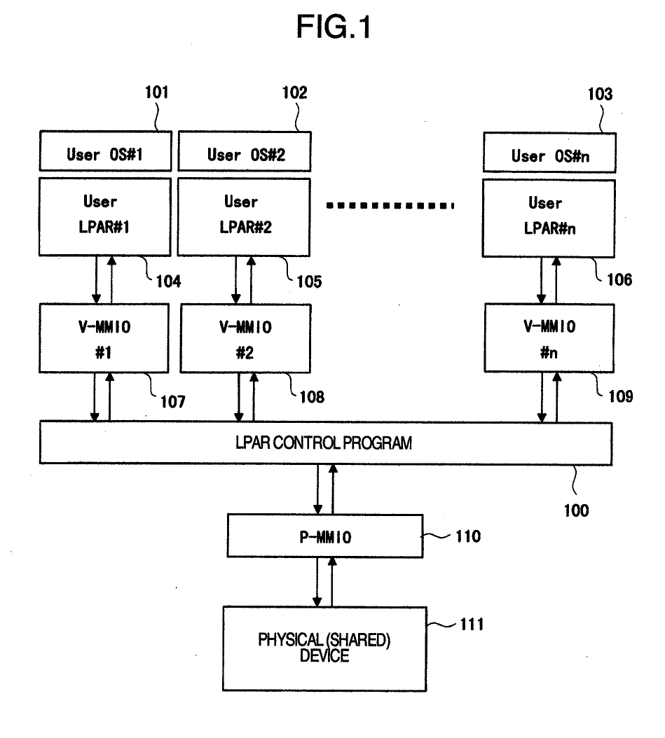

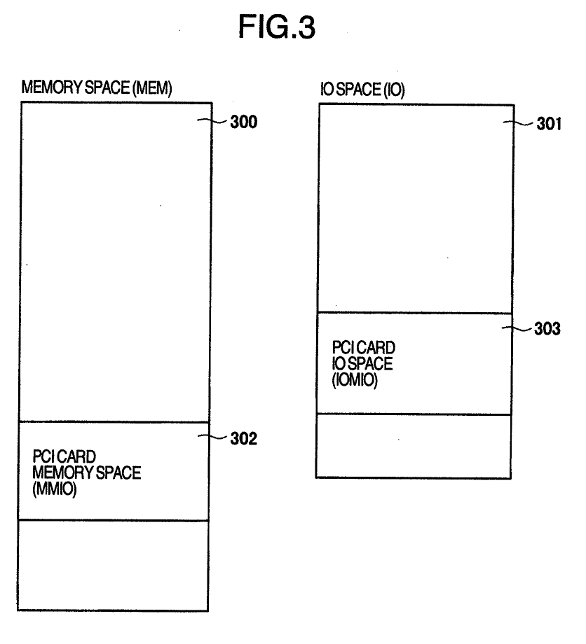

FIG. 1 illustrates a configuration example (software) of an embodiment characteristic of the present invention in the configuration in which the LPAR control program of FIG. 5 is not operated (only one operating system is operated in one computer system). In the computer system 200 supporting the LPAR function, n user LPARs 104, 105, 106 designated by User LPAR #1 to User LPAR #n rise under control of the LPAR control program 100 and n user operating systems 101, 102, 103 designated by User OS #1 to User OS #n are operated in the user LPARs 104, 105, 106, respectively. Each of n user operating systems 101, 102, 103 includes the memory space (MEM) and the IO space (IO) 301 shown in FIG. 3 independently.

The PCI cards 212, 213 are described as physical (shared) devices 111 shared by the n user operating systems 101, 102, 103 operated under control of the LPAR control program 100 by way of example.

The LPAR control program 100 writes the start address for mapping in the memory space (MEM) 300 into the memory space base address register 404 in the PCI configuration register 401, so that the PCI card 400 is mapped in the memory space (MEM) 300. The register group 514 included in the hardware of the PCI card 510 is accessed by access to P-MMIO 110 which is the PCI card memory space (MMIO) 302 mapped physically.

On the other hand, in order to map the PCI card 400 in the memory space (MEM) 300, each of the n user operating systems 101, 102, 103 instructs to write the start address for mapping in the memory space (MEM) 300 into the memory space base address register 404 in the PCI configuration register 401 independently. The LPAR control program 100 traps the writing operation instruction and does not perform writing into the memory space base address register 404 actually but makes the user operating systems 101, 102, 103 end writing operation into the memory space base address register 404 normally. Consequently, V-MMIOs 107, 108, 109 which are virtual PCI card memory spaces (MMIO) are mapped in the user operating systems 101, 102, 103. When the writing operation instruction is issued to the V-MMIOs 107, 108, 109 which are the PCI card memory spaces (MMIO) mapped virtually from the operating system, the LPAR control program 100 traps it. Then, the LPAR control program 100 performs writing in P-MMIO 110 which is PCI card memory space (MMIO) mapped physically and performs writing in the register group 514 included in hardware of the PCI card 510. When the reading operation instruction is issued to the V-MMIOs 107, 108, 109 which are the PCI card memory spaces mapped virtually from the operating system, the LPAR control program 100 traps it and pretendedly shows values of V-MMIOs 107, 108, 109 which are physically mapped PCI card memory space (MMIO) managed for each of the user operating systems 101, 102, 103 instead of performing reading from the register group 514 included in hardware of the PCI card 510.

In the same manner as mapping of V-MMIOs 107, 108, 109 which are virtual PCI card memory space (MMIO), the LPAR control program traps writing operation to the IO space base address register 405, so that the virtual PCI card IO space (IOMIO) can be mapped in the operating system. FIG. 1 illustrates only an example of V-MMIOs 107, 108, 109 which are virtual PCI card memory space (MMIO).

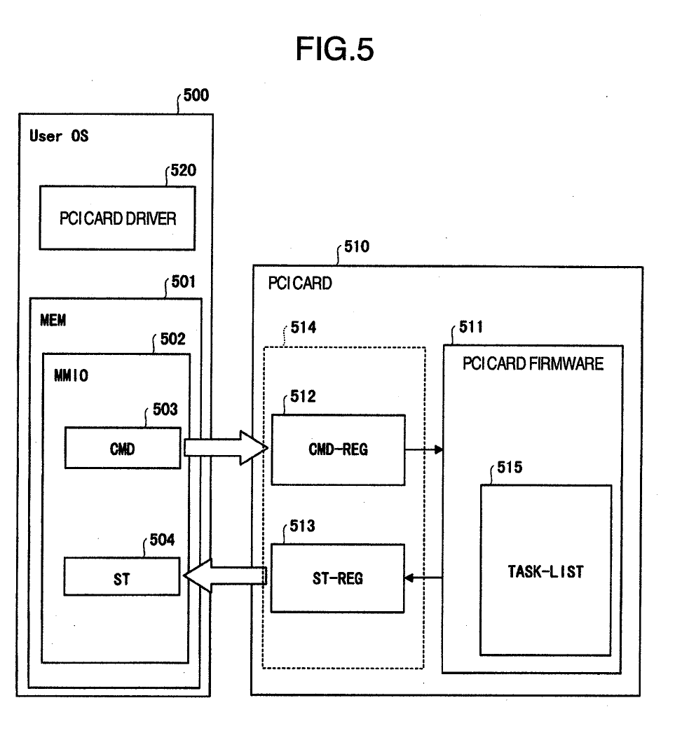

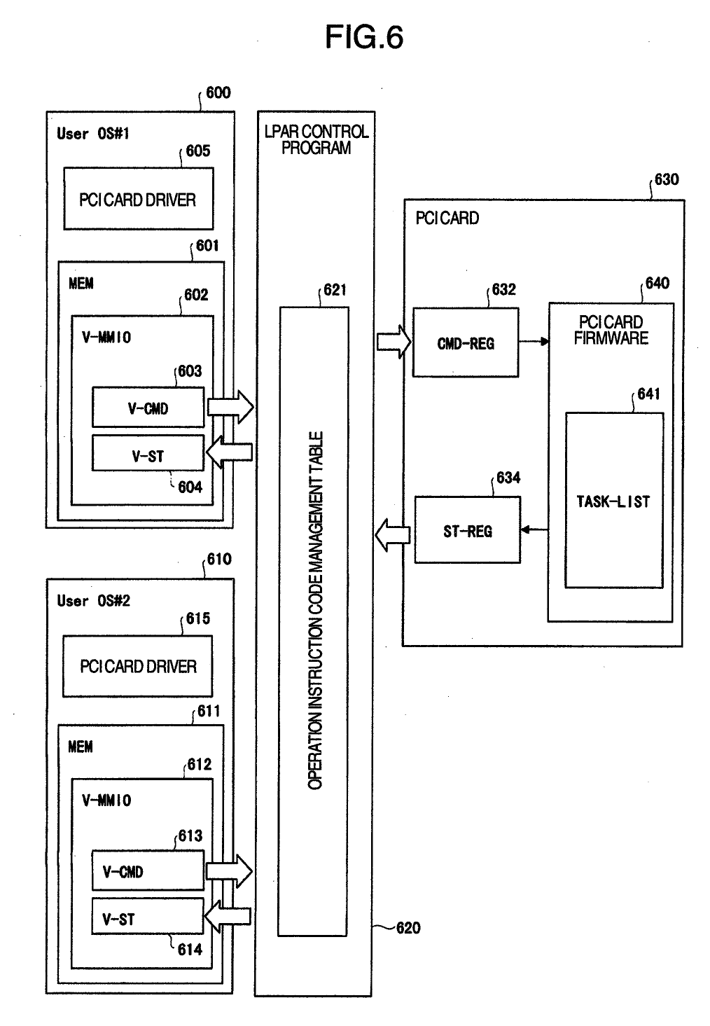

In FIG. 6, two user operating systems 600 (corresponding to the user operating system 101 of FIG. 1) and 610 (corresponding to the user operating system 102 of FIG. 1) are operated under control of the LPAR control program 620 (corresponding to the LPAR control program 100 of FIG. 1) and PCI card drivers 605 and 615 are independently operated in the respective user operating systems. Further, the user operating systems 600 and 610 include MEMs 601 and 611 which are independent memory spaces, respectively, and the MEM 601 and 611 include V-MMIOs 602 and 612 which are virtually mapped PCI card memory spaces, respectively. The V-MMIOs 602 and 612 which are virtually mapped PCI card memory space include V-CMDs 603 and 613 which are fields for accessing CMD-REG 632 in PCI card 630 (corresponding to PCI cards 212, 213 of FIG. 2) and V-STs 604 and 614 which are fields for accessing ST-REG 634, respectively, in the same manner as the configuration in which the LPAR control program is not operated.

The formats of CMD 503 and V-CMDs 603, 613 and the format of ST 504 and V-STs 604, 614 are common but the format of CMD-REG 632 is different from that of CMD-REG 513 and the format of ST-REG 634 is different from that of ST-REG 513. The format of CMD-REG 632 is shown in FIG. 9 and the format of ST-REG 634 is shown in FIG. 10. In the format of CMD-REG 632 shown in FIG. 9, part of Reserve 702 which is the unused area in CMD-REG 512 is assigned to ID-CMD (LPAR identification number field) 902 (900 represents command field, 901 parameter field and 903 reserve field). Similarly, in the format of ST-REG 634 shown in FIG. 10, part of Reserve 802 which is the unused area in ST-REG 513 is assigned to ID-ST (LPAR identification number field) 1002 (1000 represent factor field, 1001 status field and 1003 reserve field). ID-CMD 902 and ID-ST 1002 are described later.

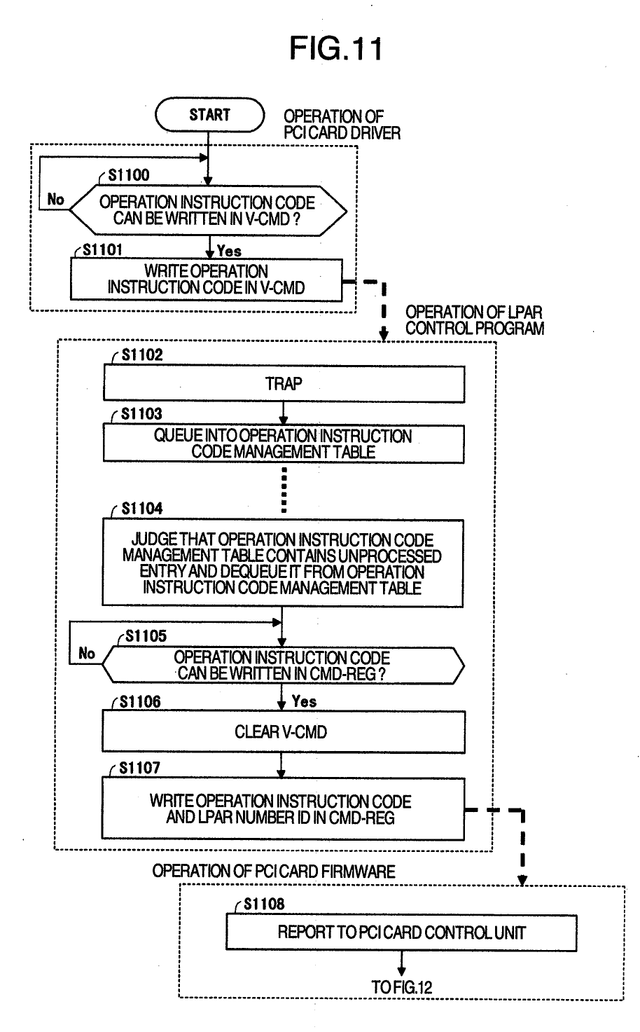

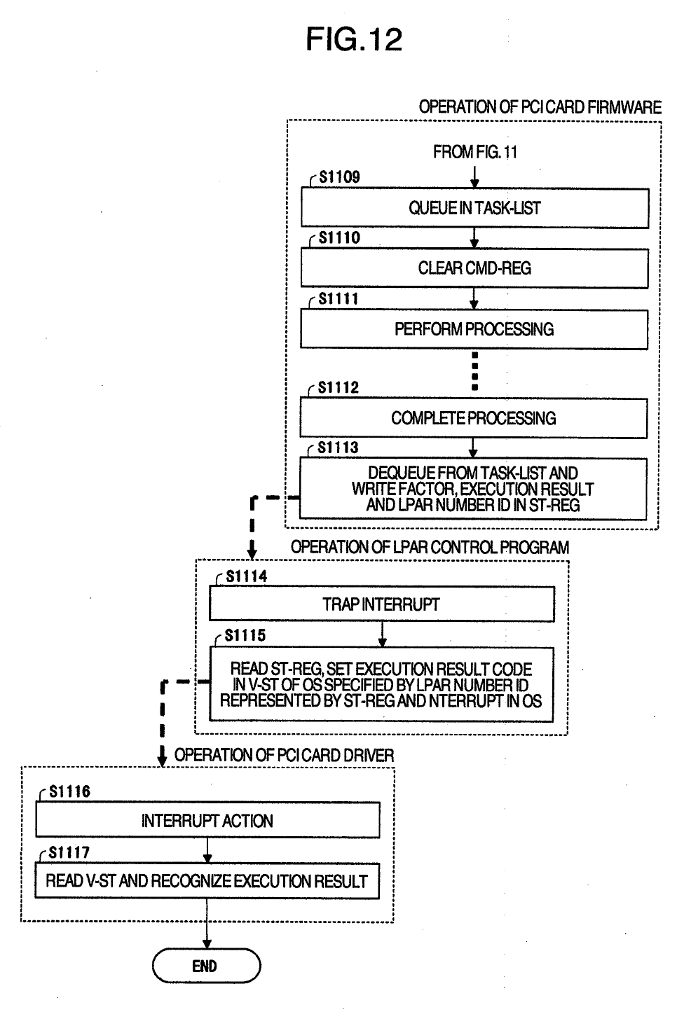

FIGS. 11 and 12 are flow charts showing operation from when the PCI card drivers 605 and 615 send operation instruction to the PCI card 630 until when an end report thereof is obtained in an embodiment to which the present invention is applied.

Referring now to FIGS. 11 and 12, the operation flow of controlling the PCI card through the PCI card memory space (MMIO) 302 in the configuration in which the LPAR control program is operated (a plurality of operating systems are operated in one computer system) is described.

In step S1100 of FIG. 11, the PCI card driver 605 operated in User OS #1 reads V-CMD 603 in order to judge whether the operation instruction code can be written in V-CMD 603 or not. When V-CMD 603 is cleared (Yes), the processing proceeds to step S1101.

In step S1101, the PCI card driver 605 writes the operation instruction code in V-CMD 603. In order to write a next new operation instruction code, the processing is returned to step S1100 again and the PCI card driver 605 confirms that V-CMD 603 is cleared. When there is no next operation instruction, the PCI card driver waits for an end report from the PCI card.

In step S1102, the LPAR control program 620 traps the writing of the operation instruction code in V-CMD 603 and the processing proceeds to step S1103.

In step S1103, the LPAR control program 620 queues the trapped operation instruction code into an operation instruction code management table 621.

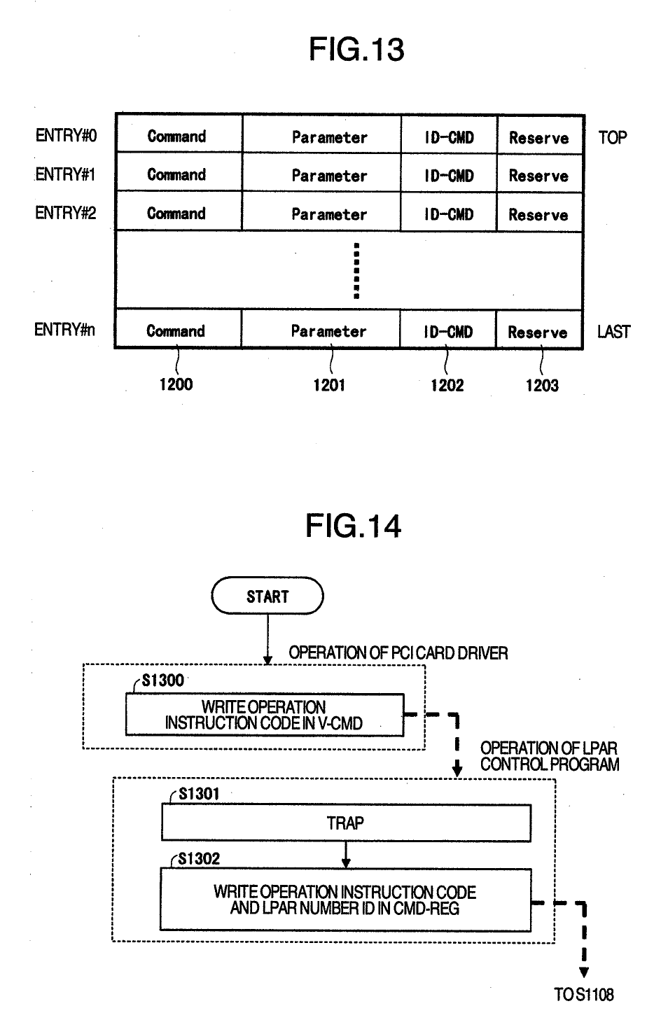

FIG. 13 shows a format of the operation instruction code management table 621. Each entry of the table has the same format as that of CMD-REG (configuration in which the LPAR control program is operated) shown in FIG. 9 and the table has the FIFO (first-in first-out) structure (1200 represents command field, 1201 parameter field, 1202 LPAR identification number field, 1203 reserve field).

In other words, in step S1103, the LPAR control program 620 adds to the trapped operation instruction code the LPAR number identifier (ID) indicating the operating system from which the operation instruction code is issued and queues it in the last place of the table. When there is further writing to V-CDMs 603 and 613, the processing from step S1102 is performed repeatedly.

In step S1104, the LPAR control program 620 judges that the operation instruction code management table 621 contains any entry which does not perform the processing from steps S1105 to S1107 and dequeues it from the top of the operation instruction code management table 621. Then, the processing proceeds to step S1105.

In step S1105, the LPAR control program 620 reads the CMD-REG 603 in order to judge whether the operation instruction code can be written in the CMD-REG 632 or not. When the CMD-REG 632 is cleared (Yes), the processing proceeds to step S1106.

In step S1106, the CMD-REG 603 is cleared in order to indicate to the PCI card driver 605 that a new operation instruction code can be written in the V-CMD 603 and the processing proceeds to step S1107.

In step S1107, the LPAR control program 620 writes data of the entry dequeued from the operation instruction code management table 621 in step S1104 into the CMD-REG 632 which is the control register within the PCI card 630. Further, when there is any unprocessed entry in the operation instruction code management table 621, the processing from step S1104 is performed repeatedly.

In step S1108, the operation instruction code and the ID are reported to the PCI card firmware 640 which controls the PCI card 630 in response to the writing into the CMD-REG 632 by the LPAR control program 620 and the processing proceeds to step S1109 of FIG. 12.

In step S1109 of FIG. 12, the PCI card firmware 640 queues the operation instruction code and the ID in TASK-LIST 641 and the processing proceeds to step S1110.

In step S1110, the CMD-REG 632 is cleared in order to indicate to the LPAR control program 620 that a next operation instruction can be written in the CMD-REG 632 and the processing proceeds to step S1111.

In step S1111, the PCI card firmware 640 starts to perform the processing in accordance with the operation instruction code in the TASK-LIST 641. When the LPAR control program 620 performs writing to new CMD-REG 632, the processing from steps S1108 to S1111 is performed. The PCI card firmware 640 can execute a plurality of operation instruction codes in the TASK-LIST 641 in parallel. There is a possibility that the order of completion of the operation instruction codes is different from that of reception thereof. The processing proceeds to step S1112 in order of the operation instruction code having the completed processing according to the operation instruction.

In step S1112, the processing according to the operation instruction is completed and the processing proceeds to step S1113.

In step S1113, the completed operation instruction code is dequeued from the TASK-LIST 641 in order of the completed operation instruction code and the execution result code and the ID received together with the operation instruction code are written in the ST-REG 634 which is the control register within the PCI card 630. An interrupt occurs on the PCI bus in response to the writing.

In step S1114, the LPAR control program 620 traps the interrupt and the processing proceeds to step S1115.

In step S1115, the LPAR control program 620 reads the ST-REG 634 which is the control register in the PCI card 630. The LPAR control program 620 specifies the User OS #1 on the basis of the ID read from the ID-ST 1002 within the ST-REG 634. The LPAR control program clears the ID-ST 1002 starting from the value read from the ST-REG 634 which is the control register within the PCI card into the V-ST 604 within the V-MMIO 602 which is the PCI card memory space virtually mapped in the User OS #1. The LPAR control program sets the execution result code in the V-ST 604 and produces an interrupt in the User OS #1.

In step S1116, the interrupt occurs in the User OS #1 and the processing proceeds to step S1117.

In step S1117, the PCI card driver 605 reads the V-ST 604 in response to the interrupt and further reads the execution result code read from the ST-REG 634 which is the control register within the PCI card. The operation instruction is completed.

The V-MMIO 612 which is the virtual PCI card memory space of the User OS #2 (610) is not changed by the control operation of the PCI card 630 executed by the User OS #1 (600).

As described above, only small correction is made to the PCI card firmware without correcting the PCI card driver operated in the operating system, so that the PCI card can be shared by the plurality of operating systems simultaneously.

Moreover, some of the PCI cards 630 include the CMD-REG 632 of the queue structure. Since judgment as to whether writing is made to the CMD-REG 632 or not in control of the PCI card is not required, the operation flow by the operation instruction to the PCI card firmware 640 is simple.

FIG. 14 is a flow chart showing another example of the operation of steps S1100 to S1107 of FIG. 11 in which replacement is made by the PCI card having the CMD-REG 632 of the queue structure. The operation in and after step S1108 is the same as that of FIGS. 11 to 12.

In step S1300, the PCI card drivers 605 and 615 write the operation instruction code in the V-CMDs 603 and 613 without confirming whether writing can be made to the V-CMDs 603 and 613 or not.

In step S1301, the LPAR control program 620 traps the writing to the V-CMDs 603 and 613 executed by the PCI card drivers 605 and 615.

In step S1302, the LPAR control program 620 writes the operation instruction code and the LPAR number identifier added thereto in the CMD-REG 632.

The subsequent operation flow is the same as that in and after step S1108 of FIG. 11.

As described above, the PCI card 630 having the CMD-REG 632 of the queue structure can be shared by a plurality of operating systems simultaneously with simpler mounting.

Further, even for an asynchronous event detected by the PCI card 630, the PCI card firmware 640 can set an asynchronous event code and an LPAR identifier (ID) in the ST-REG 634, so that the asynchronous event set in the ST-REG 634 can be reported to the User OS operated in the LPAR designated by the ID-1002 in the same operation flow as that in the case where the execution result code is reported.

As described above, according to the embodiment, since the devices can be shared by the plurality of operating systems simultaneously, a lot of devices can be connected to the operating systems logically by sharing the devices in the computer system having the physically mountable devices limited in number.

As described above, the present invention made by the Inventor has been described concretely on the basis of the embodiments, although the present invention is not limited to the embodiments and it is needless to say that various changes and modifications may be made without departing from the spirit and the scope of the invention.

1. A computer system in which a control register of a device is mapped in memory space or IO space and an operating system can control the device by access to the mapped memory space or IO space, an LPAR control program dividing the single computer system into a plurality of logical partitions, the operating system being operated in each logical partition, a plurality of operating systems capable of being operated in the single computer system simultaneously, wherein
the LPAR control program virtually maps memory space or IO space of a single physical device to each of the operating systems.

2. A computer system according to claim 1, wherein
the LPAR control program assigns an LPAR identifier for specifying the logical partition to each of the logical partitions.

3. A computer system according to claim 2, wherein
the virtual memory space or IO space mapped to each of the operation systems has information independent of other operating systems with regard to access from each of the operating systems and operation of the device.

4. A computer system according to claim 3, wherein
the LPAR control program traps the access from each of the operating systems to the virtual memory space or IO space mapped to each of the operating systems and adds the LPAR identifier corresponding to each of the operating systems thereto to make the access to physical memory space or IO space, the LPAR control program reflecting result of the access to the virtual memory space or IO space to the physical memory space or IO space individually for each of the operating systems.

5. A computer system according to claim 4, wherein
the device receives operation instruction by the access to the physical memory space or IO space and receives the LPAR identifier and contents of the operation instruction, the device processing the contents of the operation instruction, the device thereafter adding the LPAR identifier thereto to make an end report of the operation instruction to the physical memory space or IO space.

6. A computer system according to claim 5, wherein
the LPAR control program receives the LPAR identifier and the end report made to the physical memory space or IO space and specifies the logical partition on the basis of the LPAR identifier, the LPAR control program reflecting the end report to the virtual memory space or IO space of the operating system operated in the specified logical partition.

7. A computer system according to claim 3, wherein
the device sets the LPAR identifier and asynchronous event information in the physical memory space or IO space, and
the LPAR control program specifies the logical partition on the basis of the LPAR identifier and reflects the asynchronous event information to the virtual memory space or IO space of the operating system operated in the specified logical partition.

8. A method of controlling a computer system in which a control register of a physical device is mapped in memory space or IO space and an operating system controls the physical device by access to the physically mapped memory space or IO space, an LPAR control program dividing the single computer system into a plurality of logical partitions, the operating system being operated in each logical partition, a plurality of operating systems being operated in the single computer system simultaneously, wherein
the LPAR control program virtually maps memory space or IO space of a single physical device to each of the operating systems.

9. A method of controlling a computer system according to claim 8, wherein
the LPAR control program assigns an LPAR identifier for specifying the logical partition to each of the logical partitions.

10. A method of controlling a computer system according to claim 9, wherein
the virtual memory space or IO space mapped to each of the operating systems has information independent of other operating systems with regard to access from each of the operating systems and operation of the device.

11. A method of controlling a computer system according to claim 10, wherein
the LPAR control program traps the access from each of the operating systems to the virtual memory space or IO space mapped to each of the operating systems and adds the LPAR identifier corresponding to each of the operating systems thereto to make the access to physical memory space or IO space, the LPAR control program reflecting result of the access to the virtual memory space or IO space to the physical memory space or IO space individually for each of the operating systems.

12. A method of controlling a computer system according to claim 11, wherein
the device receives operation instruction by access to the physical memory space or IO space and receives the LPAR identifier and contents of the operation instruction, the device processing the contents of the operation instruction, the device thereafter adding the LPAR identifier thereto to make an end report of the operation instruction to the physical memory space or IO space.

13. A method of controlling a computer system according to claim 12, wherein
the LPAR control program receives the LPAR identifier and the end report made to the physical memory space or IO space and specifies the logical partition on the basis of the LPAR identifier, the LPAR control program reflecting the end report to the virtual memory space or IO space of the operating system operated in the specified logical partition.

14. A method of controlling a computer system according to claim 10, wherein
the device sets the LPAR identifier and asynchronous event information in the physical memory space or IO space, and
the LPAR control program specifies the logical partition on the basis of the LPAR identifier and reflects the asynchronous event information to the virtual memory space or IO space of the operating system operated in the specified logical partition.
